(19) United States
(12) Patent Application Publication
(10) Pub. No.: US 2024/0220410 A1
(43) Pub. Date: Jul. 4, 2024

(54) Leveraging System Cache for Performance Cores

(71) Applicant: Intel Corporation, Santa Clara, CA (US)

(72) Inventors: Ayan Mandal, Bangaluru (IN); Prasanna Pandit, Bengaluru (IN); Neetu Jindal, Kurukshetra (IN); Israel Diamand, Aderet M (IL); Asaf Rubinstein, Kefar (IL); Leon Polishuk, Haifa (IL); Oz Shitrit, Tel Aviv (IL)

(73) Assignee: Intel Corporation, Santa Clara, CA (US)

(21) Appl. No.: 18/089,757

(22) Filed: Dec. 28, 2022

(51) Int. Cl. G06F 12/0806

(52) U.S. Cl. CPC G06F 12/0806; G06F 2212/62

(57) ABSTRACT

Methods and apparatus relating to leveraging system cache for performance cores are described. In an embodiment, a system cache stores one or more cachelines that are to be evicted from a processor cache. Logic circuitry determines whether to store the one or more cachelines in the system cache based at least in part on comparison of a threshold value with a hit rate associated with the one or more cachelines. Other embodiments are also disclosed and claimed.

### FIELD

The present disclosure generally relates to the field of processors. More particularly, some embodiments relate to leveraging system cache for performance cores.

### BACKGROUND

Some modern processors include multiple processor cores. These processor cores may be similar/identical in some cases, while in some other cases the processor cores may be of different types (e.g., including one or more Efficient cores (“E-cores”) and one or more Performance cores (“P-cores”)). Generally, performance-oriented processor cores (such as P-cores) are physically larger with more performance for raw speed when compared to efficiency-oriented processor cores (such as E-cores). For example, P-cores may be used to run multiple software threads, while E-cores may just run a single software thread.

Moreover, to improve performance, most modern processors include on-chip cache memory. Generally, data stored in a cache is accessible by a processor many times faster than data stored in the main system memory or other more remote storage devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of various components of a System-on-Chip (“SoC” or “SOC”), in accordance with an embodiment.

FIG. 2 illustrates a flow diagram of a method for cache evictions to system cache, according to an embodiment.

FIG. 3 illustrates a flow diagram of a modified flow for evictions to a system cache, according to an embodiment.

FIG. 4 illustrates an example computing system.

FIG. 5 illustrates a block diagram of an example processor and/or System on a Chip (SoC) that may have one or more cores and an integrated memory controller.

FIG. 6(A) is a block diagram illustrating both an example in-order pipeline and an example register renaming, out-of-order issue/execution pipeline according to examples.

FIG. 6(B) is a block diagram illustrating both an example in-order architecture core and an example register renaming, out-of-order issue/execution architecture core to be included in a processor according to examples.

FIG. 7 illustrates examples of execution unit(s) circuitry.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As discussed above, some modern processors include multiple processor cores, e.g., some combination of E-cores and P-cores. Further, system cache (sometimes referred to as Memory Side Cache (MS$)) is quickly becoming an integral part of the modern System on Chip (“SoC” or “SOC”) architecture, e.g., by providing excellent power and/or performance benefits for E-cores and other low bandwidth (“BW”) Input/Output (I/O) Intellectual Property (IP) blocks such as display/media/camera by reducing the overall access to the main memory or Dynamic Random Access Memory (DRAM). However, given the goal of energy efficiency combined with relatively small capacity of the system cache, it becomes very challenging to use the same for the P-cores.

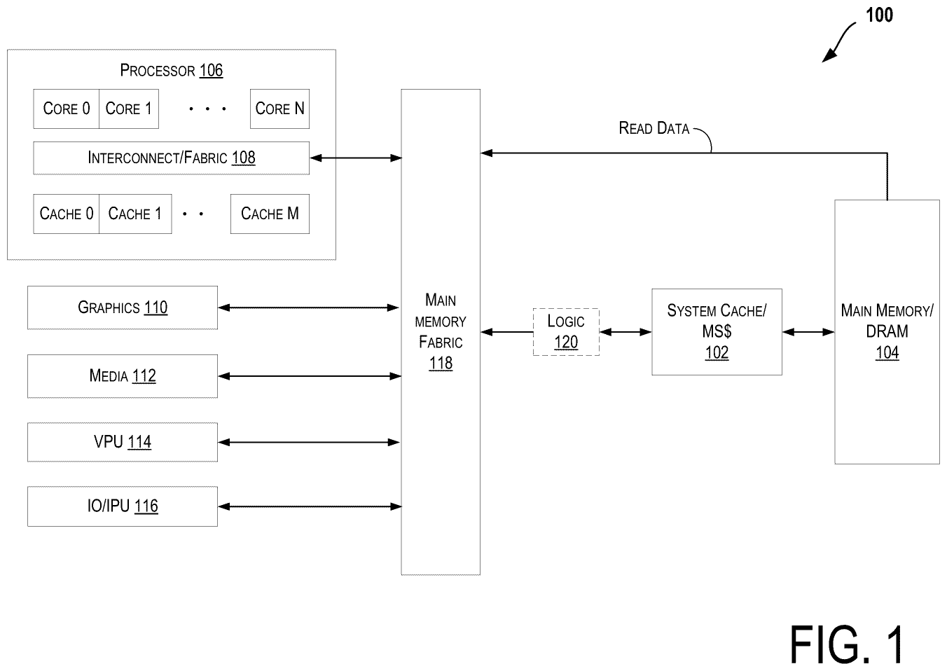

To this end, some embodiments provide techniques for leveraging system cache for performance cores. An embodiment efficiently utilizes a system cache under capacity and/or bandwidth constraints as an extended victim cache for a private Mid-Level Cache (MLC) and/or a shared Last Level Cache (LLC) for P-cores. In one embodiment, a system cache stores one or more cachelines that are to be evicted from a processor cache (e.g., an MLC and/or LLC). Logic circuitry (e.g., logic circuitry 120 of FIG. 1) determines whether to store the one or more cachelines in the system cache based at least in part on comparison of a threshold value with a hit rate associated with the one or more cachelines.

By contrast, some implementations may use system cache use system cache only for E-cores and other low bandwidth IP blocks for power savings, use system cache by filling all read misses from DRAM and modified evictions from the core for the P-cores. These implementations, however, fail to optimize performance gains, in part, because, despite having the hardware resource, the P-cores cannot extract any benefit from the system cache. Also, such implementations only work when the system cache has significantly higher capacity compared to the LLC and higher bandwidth compared to the DRAM. With these solutions having relatively smaller capacity system cache and similar bandwidth as the DRAM, there is no or very little (e.g., ten percent) power or performance upside when using system cache as a memory side cache for the P-cores.

Moreover, utilizing system cache for P-cores may, in turn, significantly improve the LLC miss latency and, hence, provide an overall performance increase. Various embodiments selectively cache only those data which are likely to be re-used, ease structural pressure on the SoC that includes the processor with E-cores and P-cores, and/or control the system cache fill bandwidth to optimize the system cache utilization.

FIG. 1 illustrates a block diagram of various components of a System-on-Chip (“SoC” or “SOC”) 100, in accordance with an embodiment. System Cache/MS$ 102 may provide excellent power and/or performance benefits for various SoC Intellectual Property (IP) blocks, e.g., by reducing the overall access latency to a main memory/DRAM 104.

As shown in FIG. 1, a processor 106 may include a plurality of processor cores (labeled as cores 0-N). The plurality of processor cores include one or more E-cores and one or more P-cores. The processor 106 also includes a plurality of caches (labeled as cache 0-M) and an interconnect or fabric 108 (e.g., to communicatively couple various components of the processor 106, including for example the cores and the caches). Various types of caches may be used in the processor 106 such as further discussed herein with reference to the remaining figures, including, for example, Level 1 cache (L1), MLC, and/or shared cache(s) (e.g., LLC).

SoC 100 may also include one or of other IP blocks such as a graphics (GT) logic/block 110, media logic/block 112, Vision Processing Unit (VPU) 114, Input/Output (“IO” or “I/O”) logic/block 116 (such as an Infrastructure Processing Unit (IPU)), etc. As shown, the processor 106 and blocks 110-116 communicate with the main memory/DRAM 104 through a main memory fabric 118. While the main memory fabric 118 may receive read data from the main memory/DRAM 104, all traffic going to the main memory/DRAM 104 is transmitted via the system cache/MS$102.

As will be discussed further herein, logic 120 performs one or more operations to leverage a system cache for P-cores. Further, while logic 120 is shown as a separate block in FIG. 1, embodiments are not limited to this configuration and system cache 102 may incorporate the logic 120, etc.

In some implementations, P-core(s) use a shared LLC as a victim cache for the private MLC where the capacity evictions from the MLC are cached in the LLC. However, caching all the MLC evictions in the LLC may result in unnecessary power and performance penalty for certain workloads. Therefore, a Dead Block Prediction (DBP) algorithm which implements selective bypassing of certain cachelines in an LLC by marking the MLC evictions as dead (where the marked cachelines have a low probability of re-use from the LLC) may be used. The DBP learning algorithm may only look at the LLC capacity to learn about the re-use and may be agnostic of the presence of the system cache. Therefore, a cacheline which is marked dead by the DBP algorithm as per LLC capacity may still have the potential to obtain hits in the system cache. Similarly, when a cacheline is evicted from LLC, there may still be potential of obtaining re-use on these evictions if they are captured in the system cache.

To this end, some embodiments identify two main candidates that can be filled into the system cache for potential re-use: (1) MLC evictions which are marked dead by a DBP algorithm; and/or (2) LLC evictions.

Moreover, there may be three challenges while trying to use the system cache for the P-Cores including, for example:
i) since the system cache has a relatively smaller capacity, sending all the dead MLC and LLC evictions may result in inversion in terms of power and/or performance for certain workloads which do not benefit from this incremental capacity;
ii) the LLC may maintain a structure called LLC Request Buffer (LRB) which is responsible for tracking all the outstanding requests to the DRAM and to guarantee coherence, LRB tracks the dead MLC and LLC evictions as well before it receives an acknowledgement from the system cache; however, the LRB being a timing critical hardware structure makes it difficult to grow the LRB without spending additional latency and, hence, this may become a bottleneck while supporting the dead MLC and LLC evictions, potentially creating performance inversions; and/or iii) the system cache may be primarily designed for energy efficiency and, hence, may not be optimized for very high bandwidth scenarios; hence, if there is a scenario with very high re-use from the system cache and the bandwidth demand is also very high, significant inversion may result in performance compared to the baseline of not using the system cache.

### Dead Eviction Bypass at LLC

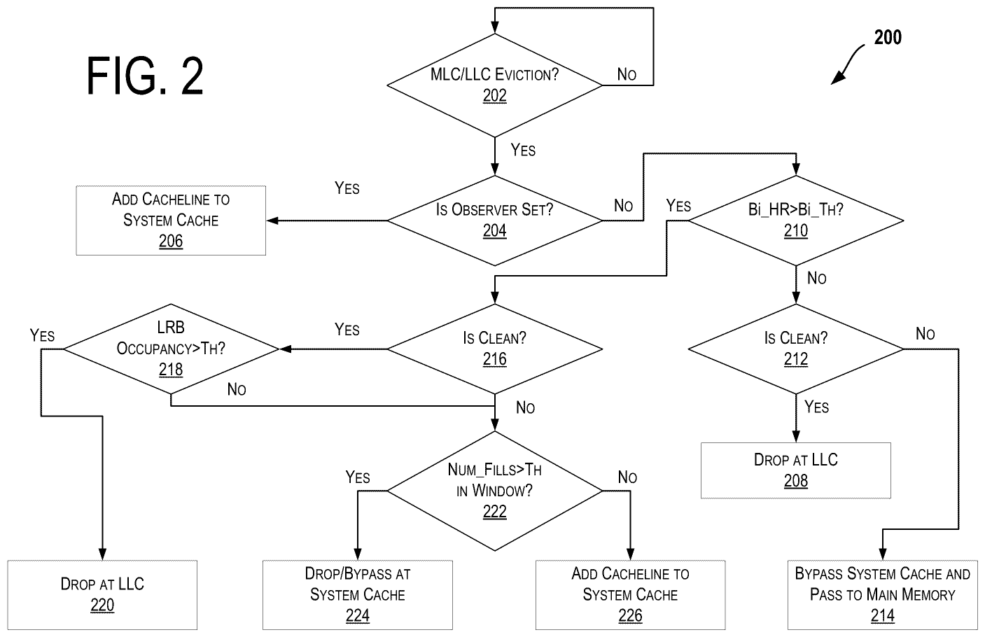

To address the problems mentioned above, FIG. 2 illustrates a flow diagram of a method 200 for cache evictions to system cache, according to an embodiment. In one embodiment, the cache evictions include MLC and/or LLC evictions. In various embodiment, one or more of the operations of method 200 are performed by the logic 120 of FIG. 1, operations 204, 210 and 212 relate to dead eviction bypass at LLC, operations 216 and 218 relate to clean eviction throttling at LLC, and operation 222 relates to eviction bypass at the system cache.

In an embodiment, two main categories are considered (referred to as system cache DBP “Bins”). The categories are determined by their source (e.g., MLC or LLC) as the installation candidates for the system cache. The two categories include: (i) Bin 0: MLC evictions marked dead by an DBP algorithm implemented at MLC; and (ii) Bin 1: LLC evictions, e.g., due to capacity constraints.

In an embodiment, a Dead Eviction Bypass (DEB) algorithm (e.g., implemented by logic 120 of FIG. 1) learns the system cache re-use behavior on some sample sets referred to as “Observer Sets” and this learning is then used for the rest of the sets referred to as “Follower Sets” (or “Non-observer Sets”).

Referring to FIGS. 1-2, upon detection of an MLC or LLC eviction at an operation 202, for each eviction in the Observer Set at an operation 204, an eviction counter may be incremented and the cacheline inserted (e.g., along with the Bin information) into the system cache at an operation 206. When a subsequent read misses in the LLC and gets a hit in the system cache Observer Set, the system cache returns the data along with the Bin information to the LLC. This information is used to increment the hit counter. The hit rates for the two DBP bins (referred to as B0_{HR} and B1_{HR}) are determined as follows:

$$B {0}_{HR} = \frac{Hit in System Cache in Bin 0}{Bin 0 Evictions Sent by LLC to System Cache}$$

$$B {1}_{HR} = \frac{Hit in System Cache in Bin 1}{Bin 1 Evictions Sent by LLC to System Cache}$$

If the eviction is in a Follower Set (as determined by operation 204), it is determined whether to bypass the eviction at an operation 208 if the corresponding DBP Bin hit rate is lower than a certain programmable threshold value at an operation 210 (e.g., approximately ten percent) signifying lower probability of re-use from the system cache. Prior to dropping the eviction at operation 208, an operation 212 determines whether the eviction is clean (i.e., not to be dropped). If the eviction is not clean, at an operation 214, the system cache is bypassed and the cacheline is added to the main memory.

Moreover, the Observer Set used for the system cache usage may be mutually exclusive from the LLC Observer Set used by the DBP algorithm implemented in the MLC for learning the LLC re-use in at least one embodiment. This is done, in part, to learn the re-use of the MLC dead evictions as all the MLC evictions are cached in the LLC for LLC Observer Sets in an embodiment and, hence, it is not possible to learn about their re-use in the system cache.

### Clean Eviction Throttling at LLC

In one embodiment, an LLC Request Buffer (LRB) keeps track of all the requests arriving at the LLC. This LRB can be a critical resource and may be generally very power hungry and increasing the capacity may be challenging from design and area complexity perspectives. The additional flow of system cache usage for the P-cores adds further pressure to the LRB since it needs to track MLC and LLC clean evictions which otherwise would have been dropped at the LLC (e.g., operation 208). To mitigate this problem, an embodiment provides a dynamic throttling scheme for clean evictions. FIG. 2 (operations 216 and 218) illustrates the modified LLC controller flow. When the system cache DEB algorithm recommends a clean eviction (either from the MLC or the LLC) to be filled in the system cache (e.g., “Yes” branch of operation 210), the LLC checks the LRB occupancy against a threshold value at operation 218 after a determination that the eviction is clean at operation 216, and allows clean eviction at operation 220 if the LRB occupancy is less than the programmable threshold at operation 218. For the allowed clean evictions, LRB may hold the request until it receives an acknowledgement from the system cache in an embodiment. Otherwise, the clean evictions are dropped at LLC at operation 220 without allocating any LRB entry.

### Eviction Bypass at System Cache

Generally, system cache may be primarily designed for energy efficiency. Some of the optimizations related to the energy efficiency may include: (1) single data bus used to both read from and write (WB) data into the system cache; (2) limit the combined read and write bandwidth to be same as the total DRAM bandwidth (e.g., implying that when any data is written to the system cache, the available read bandwidth is also reduced, which may in turn cause performance inversions for certain specific applications like a streaming load scenario where the buffer size fits in the system cache but not in the LLC).

In an SoC without a system cache, the above application would receive the DRAM bandwidth. However, with a system cache, there would be both clean evictions from the LLC and the read operations hitting in the system cache. This may result in a bandwidth loss of approximately 50%, which may be an unacceptable inversion over the baseline of no system cache. While clean eviction throttling may help reduce the impact, it may not work for modified evictions in some embodiments. This problem however may be mitigated with the proposed DEB at system cache.

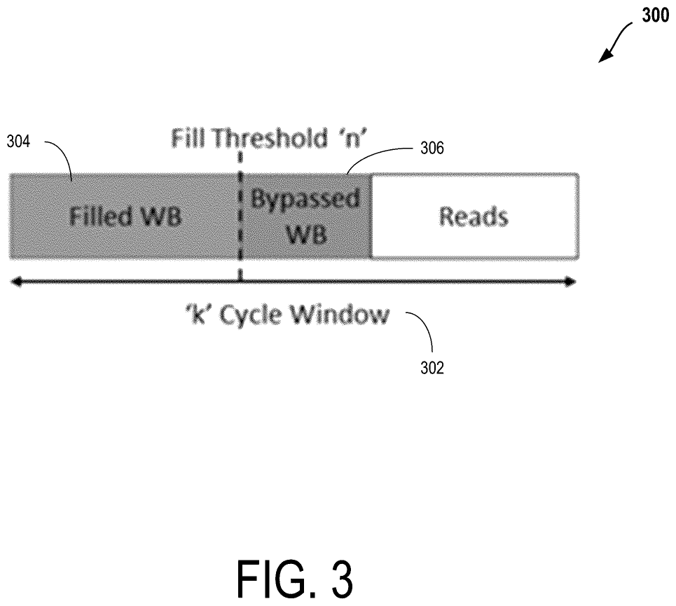

Operation 222 illustrates the modified controller flow. For example, a specified budget may be allocated for the writes into the system cache, which then frees up available bandwidth to be served for the read hits. Moreover, FIG. 3 illustrates a flow diagram of a modified flow 300 for evictions to a system cache, according to an embodiment.

Referring to FIGS. 2 and 3, in a window of ‘k’ cycles 302, only ‘n’ write operations are allowed to fill (304) into the system cache and the rest are bypassed (306). This means if the write operations are clean, they are dropped at operation 224 and if they are modified, they are send directly to the DRAM. Operation 226 adds the cacheline to the system cache if the number of fills is less than the threshold value. By limiting ‘n’ to a reasonable number, it may be ensured that Reads that hit in the system cache receive adequate bandwidth while those that miss are served from the DRAM; thus, fixing the performance inversion compared to baseline. This policy may also ensure that low bandwidth applications are not penalized with dropped fills into the system cache.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

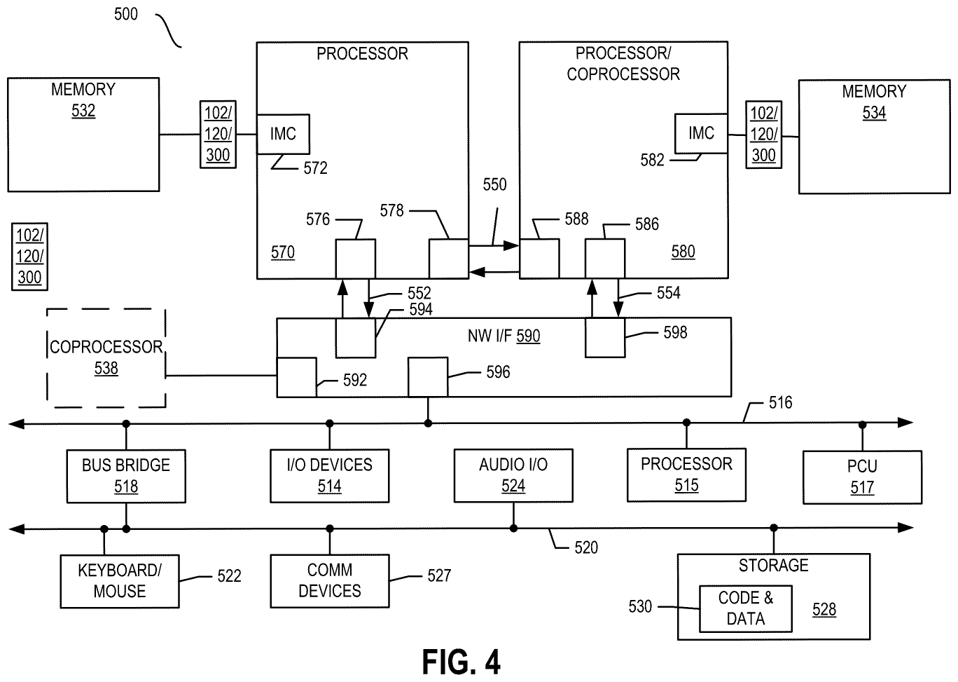

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430 and may implement the storage 'ISAB03 in some examples. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

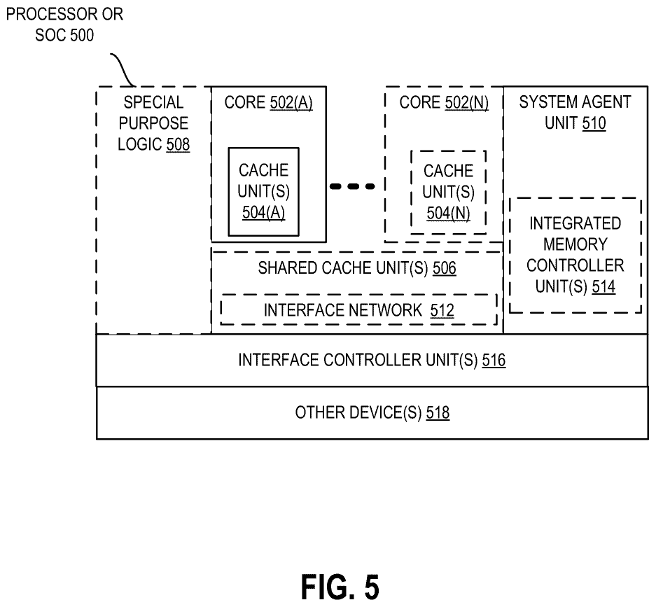

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 570 or 580, or co-processor 538 or 515 of FIG. 5.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller units circuitry 516 couple the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures—In-Order and Out-of-Order Core Block Diagram

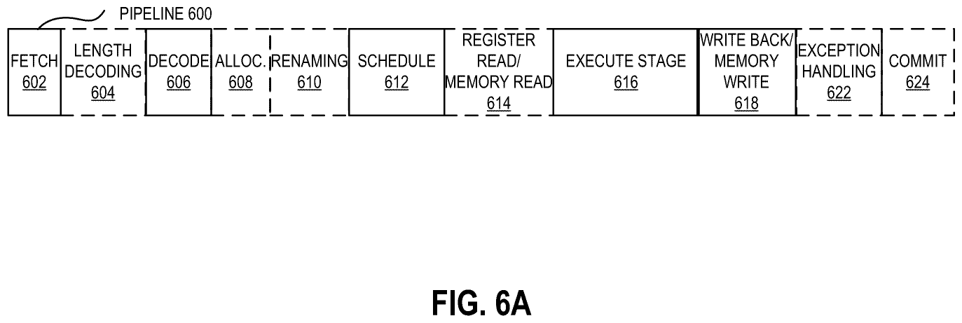

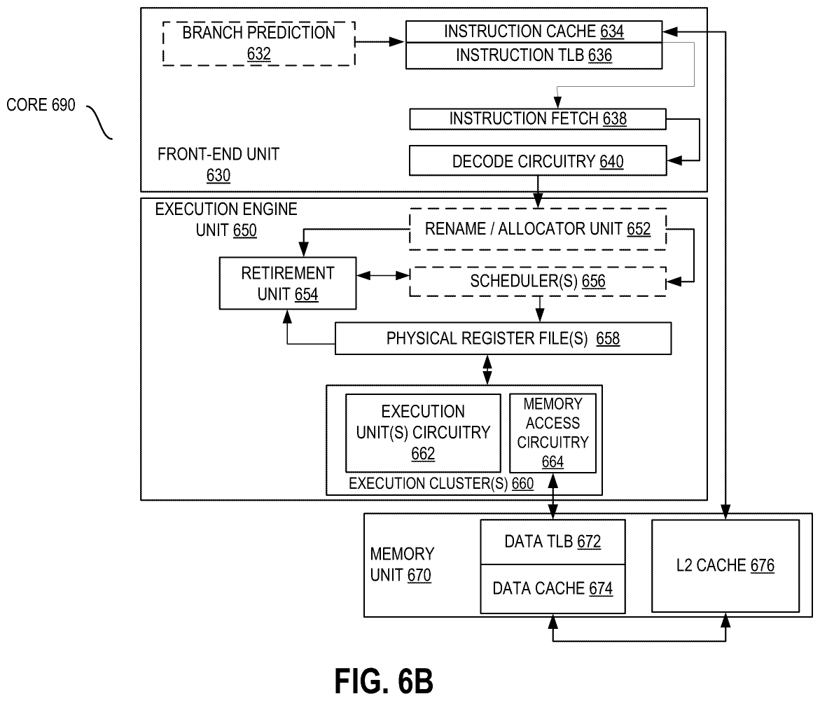

FIG. 6(A) is a block diagram illustrating both an example in-order pipeline and an example register renaming, out-of-order issue/execution pipeline according to examples. FIG. 6(B) is a block diagram illustrating both an example in-order architecture core and an example register renaming, out-of-order issue/execution architecture core to be included in a processor according to examples. The solid lined boxes in FIGS. 6(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6(A), a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6(B) may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 6) various circuitry may be involved in the exception handling stage 622; and 8) the retirement unit circuitry 654 and the physical register file(s) circuitry 658 perform the commit stage 624.

FIG. 6(B) shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry

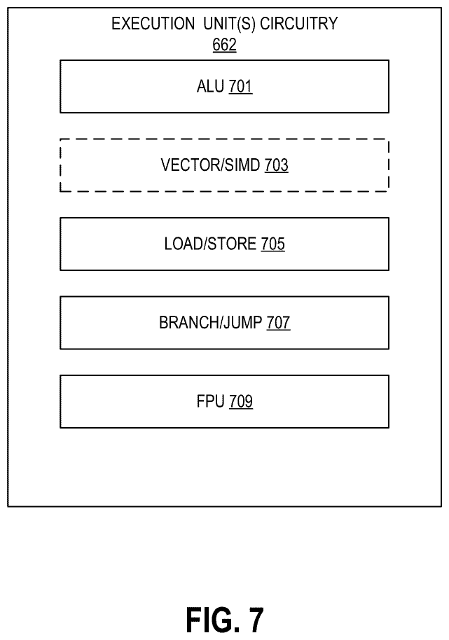

FIG. 7 illustrates examples of execution unit(s) circuitry, such as execution unit(s) circuitry 662 of FIG. 6(B). As illustrated, execution unit(s) circuitry 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: a system cache to store one or more cachelines to be evicted from a processor cache; and logic circuitry to determine whether to store the one or more cachelines in the system cache based at least in part on comparison of a threshold value with a hit rate associated with the one or more cachelines, wherein the hit rate is to be determined based on re-use behavior of an observer set of data. Example 2 includes the apparatus of example 1, wherein the logic circuitry is to apply the hit rate from the observer set of data to a plurality of follower sets of data.

Example 3 includes the apparatus of example 1, wherein the processor cache is one of a Mid-Level Cache (MLC) and a Last Level Cache (LLC). Example 4 includes the apparatus of example 3, wherein the one or more cachelines are to be evicted from the LLC in response to a determination that the LLC lacks capacity to store the one or more cachelines. Example 5 includes the apparatus of example 3, wherein the one or more cachelines are to be evicted from the MLC based at least in part on a determination that the one or more cachelines have a probability of re-use from the LLC below a certain threshold. Example 6 includes the apparatus of example 3, wherein the one or more cachelines are to be evicted from the MLC based at least in part on a determination that the one or more cachelines have a probability of re-use from the LLC below a certain threshold and are not stored in the LLC.

Example 7 includes the apparatus of example 3, wherein the one or more cachelines are to be dropped at the LLC in response to a determination that the number of requests received at the LLC exceed a select threshold value. Example 8 includes the apparatus of example 3, wherein an observer set to be used for the LLC is to be mutually exclusive from any observer set that is to be used for the MLC. Example 9 includes the apparatus of example 1, further comprising a processor, having a plurality of processor cores, coupled to the processor cache, wherein the plurality of processor cores comprise one or more efficiency-oriented processor cores and one or more performance-oriented processor cores (P-cores). Example 10 includes the apparatus of example 9, wherein the system cache is to store the one or more cachelines from the processor cache coupled to the one or more performance-oriented processor cores.

Example 11 includes the apparatus of example 9, wherein the system cache is to be store cachelines for both the one or more efficiency-oriented processor cores and the one or more performance-oriented processor cores. Example 12 includes the apparatus of example 1, wherein the logic circuitry is to be coupled between the system cache and a main memory fabric. Example 13 includes the apparatus of example 1, wherein a System on Chip comprises the logic circuitry, the processor cache, and the system cache.

Example 14 includes one or more non-transitory computer-readable media comprising one or more instructions that when executed on a processor configure the processor to perform one or more operations to cause: a system cache to store one or more cachelines to be evicted from a processor cache; and logic circuitry to determine whether to store the one or more cachelines in the system cache based at least in part on comparison of a threshold value with a hit rate associated with the one or more cachelines, wherein the hit rate is to be determined based on re-use behavior of an observer set of data.

Example 15 includes the one or more non-transitory computer-readable media of example 14, further comprising one or more instructions that when executed on the one processor configure the processor to perform one or more operations to cause the logic circuitry to apply the hit rate from the observer set of data to a plurality of follower sets of data. Example 16 includes the one or more non-transitory computer-readable media of example 14, wherein the processor cache is one of a Mid-Level Cache (MLC) and a Last Level Cache (LLC). Example 17 includes the one or more non-transitory computer-readable media of example 16, further comprising one or more instructions that when executed on the one processor configure the processor to perform one or more operations to cause the one or more cachelines to be evicted from the LLC in response to a determination that the LLC lacks capacity to store the one or more cachelines.

Example 18 includes the one or more non-transitory computer-readable media of example 16, further comprising one or more instructions that when executed on the one processor configure the processor to perform one or more operations to cause the one or more cachelines to be evicted from the MLC based at least in part on a determination that the one or more cachelines have a low probability of re-use from the LLC. Example 19 includes the one or more non-transitory computer-readable media of example 16, further comprising one or more instructions that when executed on the one processor configure the processor to perform one or more operations to cause the one or more cachelines to be dropped at the LLC in response to a determination that the number of requests received at the LLC exceed a select threshold value.

Example 20 includes the one or more non-transitory computer-readable media of example 16, further comprising one or more instructions that when executed on the one processor configure the processor to perform one or more operations to cause an observer set to be used for the LLC to be mutually exclusive from any observer set that to be used for the MLC.

Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

Further, while various embodiments described herein may use the term System-on-a-Chip or System-on-Chip (“SoC” or “SOC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system may have one or more processors (e.g., one or more processor cores) and associated circuitry (e.g., I/O circuitry, power delivery circuitry, etc.) arranged in a disaggregated collection of discrete dies, tiles, and/or chiplets (e.g., one or more discrete processor core die arranged adjacent to one or more other die such as a memory die, I/O die, etc.). In such disaggregated devices and systems, the various dies, tiles, and/or chiplets may be physically and/or electrically coupled together by a package structure including, for example, various packaging substrates, interposers, active interposers, photonic interposers, interconnect bridges, and the like. The disaggregated collection of discrete dies, tiles, and/or chiplets may also be part of a System-on-Package (“SoP”).

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a system cache to store one or more cachelines to be evicted from a processor cache; and
logic circuitry to determine whether to store the one or more cachelines in the system cache based at least in part on comparison of a threshold value with a hit rate associated with the one or more cachelines,
wherein the hit rate is to be determined based on re-use behavior of an observer set of data.

2. The apparatus of claim 1, wherein the logic circuitry is to apply the hit rate from the observer set of data to a plurality of follower sets of data.

3. The apparatus of claim 1, wherein the processor cache is one of a Mid-Level Cache (MLC) and a Last Level Cache (LLC).

4. The apparatus of claim 3, wherein the one or more cachelines are to be evicted from the LLC in response to a determination that the LLC lacks capacity to store the one or more cachelines.

5. The apparatus of claim 3, wherein the one or more cachelines are to be evicted from the MLC based at least in part on a determination that the one or more cachelines have a probability of re-use from the LLC below a certain threshold.

6. The apparatus of claim 3, wherein the one or more cachelines are to be evicted from the MLC based at least in part on a determination that the one or more cachelines have a probability of re-use from the LLC below a certain threshold and are not stored in the LLC.

7. The apparatus of claim 3, wherein the one or more cachelines are to be dropped at the LLC in response to a determination that the number of requests received at the LLC exceed a select threshold value.

8. The apparatus of claim 3, wherein an observer set to be used for the LLC is to be mutually exclusive from any observer set that is to be used for the MLC.

9. The apparatus of claim 1, further comprising a processor, having a plurality of processor cores, coupled to the processor cache, wherein the plurality of processor cores comprise one or more efficiency-oriented processor cores and one or more performance-oriented processor cores.

10. The apparatus of claim 9, wherein the system cache is to store the one or more cachelines from the processor cache coupled to the one or more performance-oriented processor cores.

11. The apparatus of claim 9, wherein the system cache is to be store cachelines for both the one or more efficiency-oriented processor cores and the one or more performance-oriented processor cores.

12. The apparatus of claim 1, wherein the logic circuitry is to be coupled between the system cache and a main memory fabric.

13. The apparatus of claim 1, wherein a System on Chip comprises the logic circuitry, the processor cache, and the system cache.

14. One or more non-transitory computer-readable media comprising one or more instructions that when executed on a processor configure the processor to perform one or more operations to cause:
a system cache to store one or more cachelines to be evicted from a processor cache; and
logic circuitry to determine whether to store the one or more cachelines in the system cache based at least in part on comparison of a threshold value with a hit rate associated with the one or more cachelines,
wherein the hit rate is to be determined based on re-use behavior of an observer set of data.

15. The one or more non-transitory computer-readable media of claim 14, further comprising one or more instructions that when executed on the one processor configure the processor to perform one or more operations to cause the logic circuitry to apply the hit rate from the observer set of data to a plurality of follower sets of data.

16. The one or more non-transitory computer-readable media of claim 14, wherein the processor cache is one of a Mid-Level Cache (MLC) and a Last Level Cache (LLC).

17. The one or more non-transitory computer-readable media of claim 16, further comprising one or more instructions that when executed on the one processor configure the processor to perform one or more operations to cause the one or more cachelines to be evicted from the LLC in response to a determination that the LLC lacks capacity to store the one or more cachelines.

18. The one or more non-transitory computer-readable media of claim 16, further comprising one or more instructions that when executed on the one processor configure the processor to perform one or more operations to cause the one or more cachelines to be evicted from the MLC based at least in part on a determination that the one or more cachelines have a low probability of re-use from the LLC.

19. The one or more non-transitory computer-readable media of claim 16, further comprising one or more instructions that when executed on the one processor configure the processor to perform one or more operations to cause the one or more cachelines to be dropped at the LLC in response to a determination that the number of requests received at the LLC exceed a select threshold value.

20. The one or more non-transitory computer-readable media of claim 16, further comprising one or more instructions that when executed on the one processor configure the processor to perform one or more operations to cause an observer set to be used for the LLC to be mutually exclusive from any observer set that to be used for the MLC.
